(19) United States
(12) Patent Application Publication
(10) Pub. No.: US 2015/0212269 A1
(43) Pub. Date: Jul. 30, 2015

(54) OPTICAL MULTIPLEXING DEVICE

(71) Applicant: FUJI ELECTRIC CO., LTD., Kawasaki-shi (JP)

(72) Inventor: Masanori OTO, Yokohama-city (JP)

(73) Assignee: FUJI ELECTRIC CO., LTD., Kawasaki-shi (JP)

(21) Appl. No.: 14/679,455

(22) Filed: Apr. 6, 2015

Related U.S. Application Data
(63) Continuation of application No. PCT/JP2013/077818, filed on Oct. 11, 2013.

(30) Foreign Application Priority Data
Nov. 19, 2012 (JP) 2012-252933

(51) Int. Cl. G02B 6/12; G02B 6/122

(52) U.S. Cl. CPC G02B 6/12007; G02B 6/122; G02B 2006/12164

(57) ABSTRACT

A plurality of second optical fibers are disposed around a first optical fiber. One ends of the second optical fibers are directed in the same direction as one end of the first optical fiber. A reflection surface faces the one end and the one ends and forms a parabolic surface. In addition, the one end is located on an extension line of an axis of the parabolic surface of the reflection surface, that is, on an extension line of an axis of a parabolic line serving as a base of the parabolic surface.

This application is a continuation under 35 U.S.C. 120 of International Application PCT/JP2013/077818 having the International Filing Date of Oct. 11, 2013, and having the benefit of the earlier filing date of Japanese Application No. 2012-252933, filed Nov. 19, 2012. Each of the identified applications is fully incorporated herein by reference.

### TECHNICAL FIELD

The present invention relates to an optical multiplexing device for multiplexing a plurality of lights.

### BACKGROUND ART

In order that a plurality of lights emitted from a plurality of laser light sources may be made incident on an optical fiber, it is necessary to multiplex those plurality of lights. Techniques for multiplexing lights are, for example, disclosed in PTLs 1 and 2. According to the technique disclosed in PTL 1, a plurality of waveguides are coupled at their one ends so as to multiplex lights. On the other hand, according to the technique disclosed in PTL 2, a plurality of input-side optical fibers are welded with an output-side optical fiber so as to multiplex lights.

Another PTL 3 discloses an optical switch device as follows. First, light incidence surfaces of a plurality of optical fibers on which an output light may be incident are aligned with one another. Then a parabolic mirror is slid in parallel to those incidence surfaces so as to change over an optical fiber on which the light should be incident.

Further, another PTL 4 discloses that a light emitted from a light source is collimated using a reflection surface which is a curved surface.

### CITATION LIST

### Patent Literature

PTL 1: JP-A-2006-330436

PTL 2: JP-A-2007-163650

PTL 3: JP-A-2008-145459

PTL 4: JP-A-2006-517675

### SUMMARY

The present inventor has investigated miniaturization of an optical multiplexing device. That is, an object of the present invention is to provide a small-sized optical multiplexing device.

According to the invention, an optical multiplexing device includes a first optical fiber, a plurality of second optical fibers, and a reflection surface. The second optical fibers are disposed around the first optical fiber. One ends of the second optical fibers are directed in the same direction as one end of the first optical fiber. The reflection surface is a parabolic surface, which faces the one end of the first optical fiber and the one ends of the second optical fibers. The one end of the first optical fiber is located on an axis of the parabolic surface.

### Advantageous Effects of Invention

According to the invention, an optical multiplexing device can be miniaturized.

### BRIEF DESCRIPTION OF THE DRAWINGS

The aforementioned object, other objects, features and advantages will be made more obvious by preferred embodiments which will be described below and the following drawings which are attached to the embodiments.

FIG. 1 is a sectional view showing the configuration of an optical multiplexing device according to a first embodiment.

FIG. 2 is a plan view for explaining the layout of a first optical fiber and second optical fibers.

FIG. 3 is a view for explaining a use example of the optical multiplexing device.

FIG. 4 is a sectional view showing the configuration of an optical multiplexing device according to a second embodiment.

FIG. 5 is a sectional view showing the configuration of an optical multiplexing device according to a third embodiment.

### DETAILED DESCRIPTION

Embodiments of the invention will be described below with reference to the drawings. Constituent parts similar to each other among the drawings are referenced correspondingly, and description thereof will be omitted accordingly.

### First Embodiment

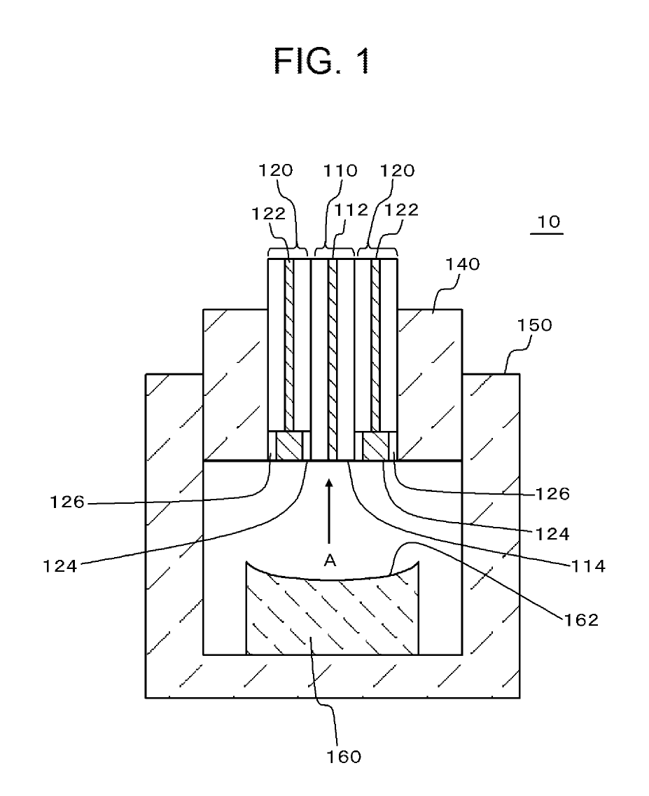

FIG. 1 is a sectional view showing the configuration of an optical multiplexing device 10 according to a first embodiment. The optical multiplexing device 10 according to the embodiment has a first optical fiber 110, a plurality of second optical fibers 120, and a reflection surface 162. The second optical fibers 120 are disposed around the first optical fiber 110. One ends 124 of the second optical fibers 120 are directed in the same direction as one end 114 of the first optical fiber 110. The reflection surface 162 is a parabolic surface, which faces the one end 114 and the one ends 124. In addition, the one end 114 is located on an extension line of an axis of the parabolic surface of the reflection surface 162, that is, on an extension line of an axis of a parabolic line serving as a base of the parabolic surface. Detailed description will be made below.

The first optical fiber 110 is provided for emitting a light multiplexed in the optical multiplexing device 10. The second optical fibers 120 are provided for making lights to be multiplexed in the optical multiplexing device 10 incident thereon. The first optical fiber 110 and the second optical fibers 120 are, for example, single-mode fibers, each having a core 112, 122. The first optical fiber 110 and the second optical fibers 120 are not limited to the single-mode fibers but may be multi-mode fibers. In addition, the one end 114 of the first optical fiber 110 and the one ends 124 of the second optical fibers 120 form one and the same surface, for example, one and the same flat surface. However, the one end 114 and the one ends 124 do not have to form one and the same surface.

A collimator 126 is provided at the front end of each second optical fiber 120. The one end 124 of the second optical fiber 120 corresponds to an end surface of the collimator 126. The collimator 126 collimates a light emitted from the second optical fiber 120. When the second optical fiber 120 is a single-mode fiber, the collimator 126 is formed by a graded index type optical fiber welded with the second optical fiber 120. In the example shown in FIG. 1, the diameter of the second optical fiber 120 and the diameter of the collimator 126 are equal to each other. However, those diameters may be different from each other.

The first optical fiber 110 and the second optical fibers 120 are bundled using one and the same annular member 140 (for example, ferrule). That is, the first optical fiber 110 and the second optical fibers 120 abut against one another. On this occasion, the second optical fibers 120 are placed to surround the first optical fiber 110. The first optical fiber 110 and the second optical fibers 120 are fixed to the inner wall of the annular member 140, for example, by use of a bonding agent.

Incidentally, the one ends 114 and 124 of the first optical fiber 110 and the second optical fibers 120 which have been fixed into the annular member 140 are polished so that the one ends 114 and 124 can be made flush with one other.

The annular member 140 is inserted into a hollow retention member 150. The retention member 150 has an optical member 160 in a hollow portion thereof. The optical member 160 is disposed in, of the hollow portion of the retention member 150, a position facing an opening portion to which the annular member 140 is inserted. The surface of the optical member 160 facing the opening portion becomes a reflection surface 162. That is, when the annular member 140 is inserted into the opening portion of the retention member 150, the one end 114 of the first optical fiber 110 and the one ends 124 of the second optical fibers 120 face the reflection surface 162.

The optical member 160 is formed, for example, out of resin, glass or the like. A reflection film which can reflect light is formed in the reflection surface 162. The reflection film is, for example, a metal thin film such as an Al thin film, but may be another film.

As described above, the reflection surface 162 has a parabolic surface. The reflection surface 162 is made into a parabolic surface, for example, by polishing. An end portion (a portion located in the one end 114) of the core 112 of the first optical fiber 110 is disposed on an extension line of an axis of the parabolic surface. This end portion preferably coincides with a focal point of the reflection surface 162. However, the end portion may be displaced from the focal point of the reflection surface 162 to some extent.

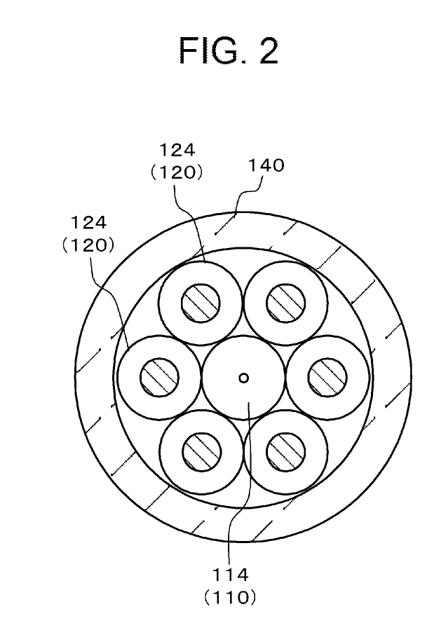

FIG. 2 is a plan view for explaining the layout of the first optical fiber 110 and the second optical fibers 120. FIG. 2 corresponds to a view from the direction A in FIG. 1. In the example shown in FIG. 2, that is, in a plane perpendicular to the central axis of the reflection surface 162 which is a parabolic surface, the second optical fibers 120 are disposed on a circumference centering the core 112 of the first optical fiber 110. In this manner, enlargement of the optical multiplexing device 10 can be suppressed even if a plurality of second optical fibers 120 are provided in the optical multiplexing device 10. In the example shown in FIG. 2, the first optical fiber 110 and the second optical fibers 120 have the same diameter, and six second optical fibers 120 are disposed around the first optical fibers 110. However, the diameter of each second optical fiber 120 may be different from the diameter of the first optical fiber 110.

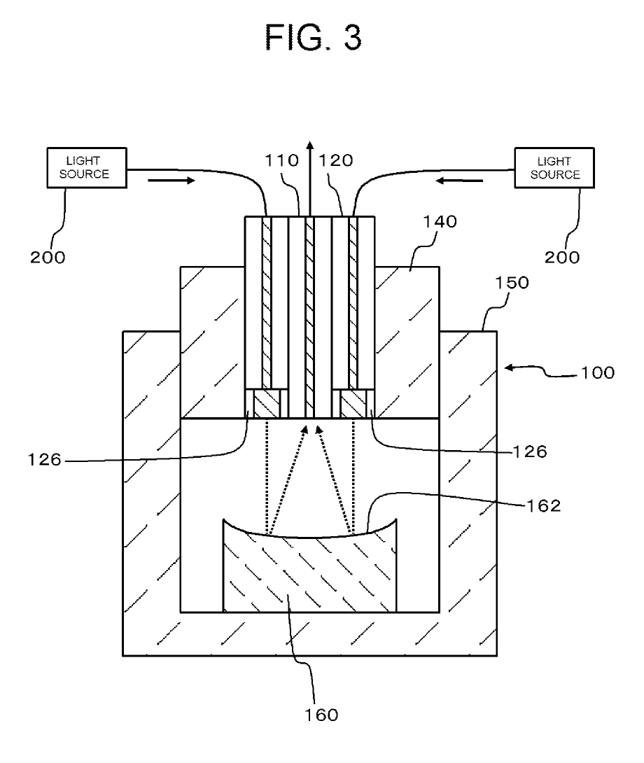

FIG. 3 is a view for explaining a use example of the optical multiplexing device 10. Lights from light sources 200 are incident on the second optical fibers 120 respectively. Each light source 200 has, for example, a laser light source. At least one light source 200 may further include a wavelength conversion element. That is, the light sources 200 may emit lights whose wavelengths coincide with one another, or at least one light source 200 may emit a light whose wavelength is different from those of the other light sources 200.

As described above, the reflection surface 162 faces the one ends 124 of the second optical fibers 120. Therefore, lights entering the second optical fibers 120 from the light sources 200 are emitted from the one ends 124 of the second optical fibers 120 and applied onto the reflection surface 162. The first optical fiber 110 is located on the extension line of the axis of the parabolic surface of the reflection surface 162. Therefore, most of the lights reflected on the reflection surface 162 enter the first optical fiber 110. In this manner, all of the lights emitted from the light sources 200 are multiplexed in the first optical fiber 110 and emitted to the outside.

Here, the position of the reflection surface 162 and the positions of the second optical fibers 120 with respect to the first optical fiber 110 are set so that the incident angles of the lights in the one end 114 of the first optical fiber 110 can be made smaller than the critical angle of the core 112.

Incidentally, when the collimators 126 are provided at the front ends of the second optical fibers 120, the lights emitted from the second optical fibers 120 are collimated. Therefore, the lights can enter the first optical fiber 110 with high efficiency. In addition, when the first optical fiber 110 is located at the focal point of the reflection surface 162, the lights emitted from the second optical fibers 120 can enter the first optical fiber 110 with high efficiency.

An apparatus provided with the light sources 200 and the optical multiplexing device 10 is, for example, used as a light source for an optical signal transmitting apparatus, a spectroscopic measurement apparatus or a spectroscopic analysis apparatus, a light source for a laser machining apparatus, a light source for a laser microscope, alight source for a DNA analysis apparatus, a light source for an endoscope, or a light source for a funduscopy apparatus.

According to the embodiment, as has been described, all of the one end 114 of the first optical fiber 110 and the one ends 124 of the second optical fibers 120 face the reflection surface 162. The reflection surface 162 forms a parabolic surface. The one end 114 is located on the extension line of the axis of the parabolic surface of the reflection surface 162. Therefore, all of the lights emitted from the one ends 124 of the second optical fibers 120 enter the one end 114 of the first optical fiber 110. Thus, a plurality of lights can be multiplexed by use of the optical multiplexing device 10. In addition, the optical multiplexing device can be constituted by the first optical fiber 110, the second optical fibers 120 and the reflection surface 162. Thus, the optical multiplexing device can be miniaturized.

Further, the optical coupling system of the optical multiplexing device 10 is formed out of a reflection optical system. Accordingly, the optical coupling system may be hardly affected by chromatic aberration when lights incident on the second optical fibers 120 are in a visible light region, for example, when the wavelengths of the lights are in a range not shorter than 400 nm and not longer than 600 nm.

### Second Embodiment

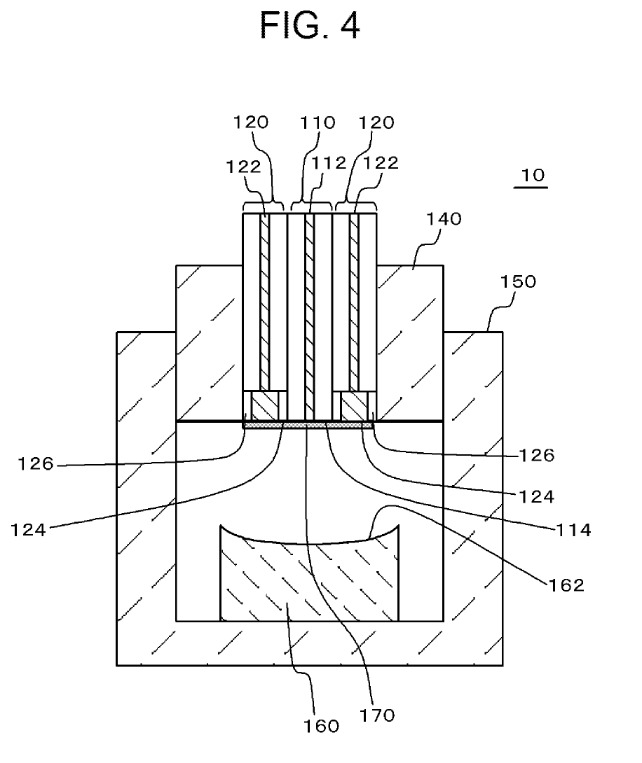

FIG. 4 is a sectional view showing the configuration of an optical multiplexing device 10 according to a second embodiment. The optical multiplexing device 10 according to the second embodiment has the same configuration as the optical multiplexing device 10 according to the first embodiment, except that the optical multiplexing device 10 according to the second embodiment includes an antireflection film 170.

The antireflection film 170 is provided on the one end 114 of the first optical fiber 110 and the one ends 124 of the second optical fibers 120. In the example shown in FIG. 4, the one end 114 and the one ends 124 form one and the same surface. Therefore, the antireflection film 170 is formed as a continuous film on the one end 114 and the one ends 124. The antireflection film 170 is, for example, a dielectric film, which is formed using a deposition method or the like.

Also according to the embodiment, a similar effect to that of the first embodiment can be obtained. In addition, due to the antireflection film 170 formed on the one end 114 and the one ends 124, lights can be multiplexed with higher efficiency.

### Third Embodiment

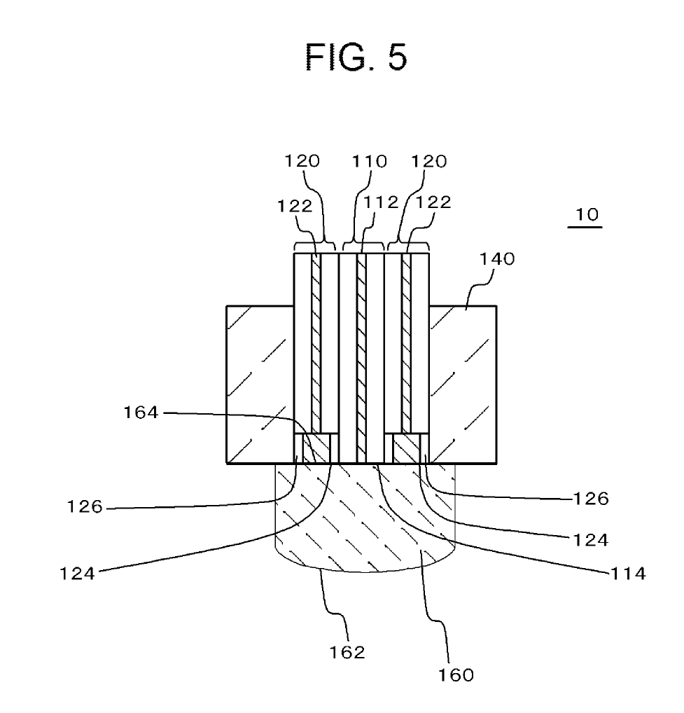

FIG. 5 is a sectional view showing the configuration of an optical multiplexing device 10 according to a third embodiment. The optical multiplexing device 10 according to the third embodiment has the same configuration as the optical multiplexing device 10 according to the first embodiment, except for the following points.

First, the optical member 160 is formed out of a translucent material (such as glass or translucent resin). The reflection surface 162 of the optical member 160 is formed in, of the optical member 160, an opposite surface 164 to the surface facing the first optical fiber 110 and the second optical fibers 120. The surface 164 abuts against the one end 114 of the first optical fiber 110 and the one ends 124 of the second optical fibers 120. Specifically, the surface 164 is a flat surface, which abuts against the flat surface consisting of the one end 114 and the one ends 124.

Incidentally, the reflection surface 162 may be processed into a parabolic surface after the optical member 160 is bonded to the first optical fiber 110 and the second optical fibers 120. Alternatively, the optical member 160 may be bonded to the first optical fiber 110 and the second optical fibers 120 after the reflection surface 162 is processed into a parabolic surface. In any case, a reflection film may be formed on the reflection surface 162 at any timing as long as the reflection surface 162 has been processed into a parabolic surface.

In the embodiment, lights emitted from the one ends 124 of the second optical fibers 120 are passed through the optical member 160 and reflected on the reflection surface 162. The reflected lights are passed through the optical member 160 and incident on the first optical fiber 110.

In this manner, also according to the embodiment, a similar effect to that of the first embodiment can be obtained. In addition, it will go well if the surface 164 of the optical member 160 is attached to the one end 114 of the first optical fiber 110 and the one ends 124 of the second optical fibers 120. Thus, the number of man-hours for manufacturing the optical multiplexing device 10 can be reduced. Incidentally, also in this embodiment, the antireflection film 170 may be provided.

The embodiments of the invention have been described above with reference to the drawings. The embodiments exemplify the invention, but various configurations other than the aforementioned configurations may be used.

The present application claims priority based on Japanese Patent Application No. 2012-252933 filed on Nov. 19, 2012, the contents of which will be incorporated herein by reference.

What is claimed is:

1. An optical multiplexing device comprising:
a first optical fiber;
a plurality of second optical fibers which are disposed around the first optical fiber and one ends of which are directed in a same direction as one end of the first optical fiber; and
a reflection surface which faces the one end of the first optical fiber and the one ends of the second optical fibers and which forms a parabolic surface; wherein:
the one end of the first optical fiber is located on an extension line of an axis of the parabolic surface.

2. The optical multiplexing device according to claim 1, wherein:
the one end of the first optical fiber is located at a focal point of the parabolic surface.

3. The optical multiplexing device according to claim 2, further comprising:
collimators which are provided in the one ends of the second optical fibers respectively.

4. The optical multiplexing device according to claim 1, wherein:
the second optical fibers are disposed on a circumference centering the first optical fiber in a plane perpendicular to a central axis of the reflection surface.

5. The optical multiplexing device according to claim 4, further comprising:
a translucent optical member one surface of which abuts against the one end of the first optical fiber and the one ends of the second optical fibers while an opposite surface to the one surface forms a parabolic surface; and
an optical reflection film which is formed on the parabolic surface.

6. The optical multiplexing device according to claim 5, wherein:
the one end of the first optical fiber and the one ends of the second optical fibers form one and the same flat surface; and
the one surface of the translucent optical member is a flat surface.

7. The optical multiplexing device according to claim 6, further comprising:
a first antireflection film which is provided on the one end of the first optical fiber; and
second antireflection films which are provided on the one ends of the second optical fibers.

8. The optical multiplexing device according to claim 1, wherein:
the first optical fiber includes a core; and
a position of the reflection surface and positions of the second optical fibers with respect to the first optical fiber are configured so that incident angles of lights in the one end of the first optical fiber can be made smaller than a critical angle of the core.

9. The optical multiplexing device according to claim 2, wherein:
the second optical fibers are disposed on a circumference centering the first optical fiber in a plane perpendicular to a central axis of the reflection surface.

10. The optical multiplexing device according to claim 3, wherein:
the second optical fibers are disposed on a circumference centering the first optical fiber in a plane perpendicular to a central axis of the reflection surface.

11. An apparatus, comprising:
a plurality of optical fibers having ends that oppose a reflective parabolic surface;
wherein the plurality of optical fibers includes an axial optical fiber that is substantially aligned with a central axis of the reflective parabolic surface.

12. The apparatus of claim 11, further comprising a retention member and an optical member, wherein the optical member is on a lower surface of the retention member and the reflective parabolic surface is formed on an upper surface of the optical member.

13. The apparatus of claim 11, wherein the parabolic surface is formed on a lower surface of an optical member having an upper surface that abuts the ends of the plurality of optical fibers.

14. The apparatus of claim 11, further comprising at least one anti-reflection film on the ends of the plurality of optical fibers.

15. The apparatus of claim 11, further comprising:
a retention member; and
an annular member having at least a portion within the retention member;
wherein at least a portion of the plurality of optical fibers is within the annular member.

16. The apparatus of claim 15, wherein the plurality of optical fibers includes peripheral optical fibers arranged around a periphery of the axial optical fiber.

17. The apparatus of claim 16, wherein each of the peripheral optical fibers has a collimator at the end that opposes the reflective parabolic surface.

18. The apparatus of claim 17, wherein the peripheral optical fibers are configured to emit light to be reflected by the reflective parabolic surface.

19. The apparatus of claim 18, further comprising light sources coupled to the peripheral optical fibers.

20. The apparatus of claim 18, wherein the axial optical fiber includes a core having a critical angle, and the peripheral optical fibers and the reflective parabolic surface are arranged so that the light emitted by the peripheral optical fibers and reflected by the reflective parabolic surface is incident on the end of the axial optical fiber that opposes the reflective parabolic surface at an angle smaller than the critical angle.
